(19) United States
(12) Patent Application Publication
(10) Pub. No.: US 2023/0122468 A1
(43) Pub. Date: Apr. 20, 2023

(54) NEGATIVE ELECTRODE FOR RECHARGEABLE LITHIUM BATTERY AND RECHARGEABLE LITHIUM BATTERY INCLUDING SAME

(71) Applicant: Samsung SDI Co., Ltd., Yongin-si (KR)

(72) Inventors: Minjae KIM, Yongin-si (KR); Kyoseon KOO, Yongin-si (KR); Junghyun NAM, Yongin-si (KR); Jeunggi MOON, Yongin-si (KR); Hyo-jung SONG, Yongin-si (KR); Mihwa YANG, Yongin-si (KR); Duckjae YOU, Yongin-si (KR); Jinhee LEE, Yongin-si (KR); Sungsoo HAN, Yongin-si (KR)

(21) Appl. No.: 17/963,010

(22) Filed: Oct. 10, 2022

(30) Foreign Application Priority Data
Oct. 14, 2021 (KR) 10-2021-0136834

(51) Int. Cl. H01M 4/62; H01M 4/133; H01M 4/134; H01M 4/587; H01M 4/38; H01M 4/36

(52) U.S. Cl. CPC H01M 4/628; H01M 4/133; H01M 4/134; H01M 4/587; H01M 4/386; H01M 4/364; H01M 4/623; H01M 4/366; H01M 2004/027

(57) ABSTRACT

Disclosed are a negative electrode for a rechargeable lithium battery and a rechargeable lithium battery including the same, the negative electrode including a current collector, a negative active material layer on the current collector, including a silicon-based negative active material, and an adhesive layer on the negative active material layer, wherein the adhesive layer has a thickness of about 5 μm or less, the adhesive layer has an area of about 50 area % based on the total area of the negative active material layer, and the adhesive layer is positioned in a dot pattern.

### CROSS-REFERENCE TO RELATED APPLICATION

This application claims priority to and the benefit of Korean Patent Application No. 10-2021-0136834 filed in the Korean Intellectual Property Office on Oct. 14, 2021, the entire contents of which are hereby incorporated by reference.

### BACKGROUND

### 1. Field

Embodiments of the present disclosure relate to a negative electrode for a rechargeable lithium battery and a rechargeable lithium battery.

### 2. Description of the Related Art

Recently, the rapid supplement of electronic devices such as mobile phones, laptop computers, and electric vehicles, using batteries requires surprising increases in demands for rechargeable batteries having relatively high capacity and lighter weight. For example, a rechargeable lithium battery has drawn attention as a driving power source for portable devices, as it has lighter weight and high energy density. Accordingly, research for improving performance of rechargeable lithium batteries is actively being performed.

A rechargeable lithium battery includes a positive electrode and a negative electrode which may include an active material capable of intercalating and deintercalating lithium ions, and an electrolyte, and generates electrical energy due to an oxidation and reduction reaction when lithium ions are intercalated and deintercalated into the positive electrode and the negative electrode.

As for a positive active material of a rechargeable lithium battery, transition metal compounds such as lithium cobalt oxides, lithium nickel oxides, and lithium manganese oxides are mainly used. As the negative active material, a crystalline carbonaceous material such as natural graphite or artificial graphite, or an amorphous carbonaceous material, may be used.

Nowadays, the negative active material layer has been thickly formed in order to improve the energy density of the rechargeable lithium battery, and especially, it has been attempted to prepare a negative active material layer in the form of double layer using a silicon-based active material.

The above information disclosed in this Background section is only for enhancement of understanding of the background of the present disclosure, and therefore it may contain information that does not form the prior art that is already known in this country to a person of ordinary skill in the art.

### SUMMARY

One embodiment provides a negative electrode for a rechargeable lithium battery capable of suppressing or reducing extraction and expansion (e.g., contraction and expansion) of volume during repeated charging and discharging, and exhibiting good adherence and excellent cycle-life characteristics.

Another embodiment provides a rechargeable lithium battery including the negative electrode.

One embodiment provides a negative electrode for a rechargeable lithium battery including a current collector, a negative active material layer on the current collector, including a silicon-based negative active material, and an adhesive layer on the negative active material layer; wherein the adhesive layer has a thickness of about 5 μm or less, the adhesive layer has an area of about 50 area % based on the total area of the negative active material layer, and the adhesive layer is positioned in a dot pattern.

The adhesive layer may have a thickness of about 1 μm to about 5 μm.

The adhesive layer may have an area of about 5 area % to about 50 area % based on the total area of the negative active material layer.

The adhesive layer may include an acryl-based binder and a fluorine-based binder.

A mixing ratio of the acryl-based binder and the fluorine-based binder may be about 75:25 by weight ratio to about 50:50 by weight ratio.

The acryl-based binder may include poly(meth)acrylic acid, poly(meth)acrylate, polymethyl(meth)acrylate, polyacrylonitrile, an acrylonitrile-styrene-butadiene copolymer, a copolymer thereof, a mixture thereof, or a combination thereof.

The fluorine-based binder may include polyvinylidene fluoride, polyvinylidene fluoride-co-hexafluoropropylene, polyvinylidene fluoride-co-trichloroethylene, polyvinylidene fluoride-co-tetrafluoroethylene, polyvinylidene fluoride-co-trifluoroethylene, polyvinylidene fluoride-co-trifluoro chloroethylene and polyvinylidene fluoride-co-ethylene, or a combination thereof.

The negative electrode may have bending strength of about 0.5 N or less.

The negative electrode may further include a carbon-based negative active material.

Another embodiment provides a rechargeable lithium battery including the negative electrode, a positive electrode, and an electrolyte.

The negative electrode according to one embodiment may exhibit excellent adhesion and cycle-life characteristics.

### BRIEF DESCRIPTION OF THE DRAWINGS

The accompanying drawings, together with the specification, illustrate embodiments of the subject matter of the present disclosure, and, together with the description, serve to explain principles of embodiments of the subject matter of the present disclosure.

FIG. 1 is a cross-sectional view of a negative active material layer and an adhesive in a negative electrode for a rechargeable lithium battery according to one embodiment.

FIG. 2 is a perspective view of a rechargeable lithium battery according to an embodiment of the present disclosure.

FIG. 3 shows scanning electron microscope (SEM) photographs for respective negative active material layers according to Examples 1 to 3 and Comparative Examples 1 and 2.

FIG. 4 shows SEM photographs for the respective negative active material layers according to Examples 1 to 3.

FIG. 5 is a graph showing the bending strength of respective negative electrodes according to Examples 1 to 3 and Comparative Examples 1 and 2.

FIG. 6 is a graph showing the cycle-life characteristics of respective half-cells according to Examples 1 to 3 and Comparative Examples 1 and 2.

### DETAILED DESCRIPTION

Hereinafter, embodiments of the present disclosure are described in more detail. However, these embodiments are merely examples, the present disclosure is not limited thereto, and the scope of the present disclosure is defined by the scope of the appended claims, and equivalents thereof.

The terms used herein are merely used to explain example embodiments, but are not intended to limit the present disclosure. Expressions in the singular may include the plural unless the context clearly dictates otherwise.

The term “combination” thereof may include a mixture, a laminate, a complex, a copolymer, an alloy, a blend, and/or a reaction product of constituents.

The terms “comprise”, “include”, and “have” are intended to designate that the performed characteristics, numbers, step, constituted elements, or a combination thereof are present, but it should be understood that the possibility of presence or addition of one or more other characteristics, numbers, steps, constituted elements, or a combination are not to be precluded in advance.

The drawings show that the thickness may be enlarged in order to clearly show the various layers and regions, and the same reference numerals are given to similar parts throughout the specification. When an element, such as a layer, a film, a region, a plate, and the like is referred to as being “on” or “over” another part, it may include cases where it is “directly on” another element, but also cases where there is another element in between. In contrast, when an element is referred to as being “directly on” another element, there are no intervening elements present.

As described herein, a “thickness”, for example, may be measured via a photograph using an optical microscope, or, for example, a scanning electron microscope (SEM) and/or the like.

A negative electrode for a rechargeable lithium battery according to one embodiment includes a current collector, a negative active material on the current collector, including a silicon-based negative active material, and an adhesive layer on the negative active material layer.

The adhesive layer on the negative active material layer including the silicon-based negative active material may improve stiffness (e.g., rigidity) of the negative electrode, thereby effectively suppressing or reducing extraction and expansion (e.g., contraction and expansion) of the silicon-based negative active material during charging and discharging. Furthermore, the strength of the negative electrode may be improved. The shrinkage or expansion of the carbon-based negative active material does not severely occur so that the effects for suppressing or reducing shrinkage and expansion of volume by forming the adhesive layer on the negative active material layer is not enlarged, and the adhesive layer adversely acts as a resistance. For example, because the contraction and expansion of the carbon-based negative active material upon discharging and charging is not as severe as that of the silicon-based negative active material layer, the adhesive layer does not substantially reduce the contraction and expansion of the carbon-based negative active material and instead adversely increases the electrical resistance of the corresponding negative electrode. Thus, the effects by forming the adhesive layer on the active material layer may be obtained for only adopting the active material layer including the silicon-based negative active material. For example, embodiments of the adhesive layer provide benefits in reducing contraction and expansion that are only observed for the silicon-based negative active material, and, unlike other negative active materials, the benefits of including the adhesive layer outweigh any potential corresponding adverse effects.

The adhesive layer may be present in a dot pattern (e.g., may be formed as a plurality of discrete adhesive layers that do not physically contact one another).

The adhesive layer may have a thickness of about 5 μm or less, or about 1 μm to about 5 μm. If the thickness of the adhesive layer is more than 5 μm, the adhesive layer is too thick which causes a relatively large decrease in capacity. As described herein, the thickness of the adhesive layer refers to a length from a surface of the negative active material layer to the upper surface of the adhesive layer. For example, if the adhesive layer has a dot pattern, the thickness refers to a diameter or height of a dot.

The position of the adhesive layer on the negative active material layer in a dot pattern indicates to partially cover the negative active material layer, rather than to substantially and completely cover the negative active material layer. For example, the adhesive layer may only partially cover the negative active material layer, rather than completely covering the negative active material layer.

According to one embodiment, an area of the adhesive layer may be about 50 area % or less of the total area of the negative active material layer (e.g., based on area 100 area % of the negative active material layer as a reference), about 5 area % to about 50 area %, or about 5 area % to about 25 area %. This indicates that the adhesive layer is presented to cover an area corresponding to about 50 area % of the total surface, 100 area %, of the negative active material layer. For example, the adhesive layer may be on a surface of the negative active material layer and the adhesive layer may cover 50% or less of a total area of the surface of the negative material layer, and thus, the area % described herein may be relative to one surface of the negative active material layer and not a total area of all surfaces of the negative active material layer.

When the area of the adhesive layer is about 50 area % or less of the total area of the negative active material layer, according to one embodiment, about 5 area % to 50 area % of the total area of the negative active material layer, and according to another embodiment, about 5 area % to about 25 area % of the total area of the negative active material layer, suitable strength may be exhibited and excellent cycle-life characteristic may be exhibited.

In one embodiment, the adhesive layer area may be obtained from a SEM photograph for the negative active material layer in which a bright portion (e.g., a white portion) corresponds to an adhesive layer, so that the area of the bright portion may be calculated.

The adhesive layer may include an acryl-based binder and a fluorine-based binder. The acryl-based binder provides adhesion between the adhesive layer and the active material layer, and may be a polymer and/or a copolymer including an acryl group, and/or a polymer and/or a copolymer including a modified acryl group. The acryl-based binder may be poly(meth)acrylic acid, poly(meth)acrylate, polymethyl(meth)acrylate, polyacrylonitrile, an acrylonitrile-styrene-butadiene copolymer, a copolymer thereof, a mixture thereof, or a combination thereof.

The fluorine-based binder serves to provide pores to the adhesive layer, as the fluorine-based binder itself has hardness and low electrolyte impregnation so that the deformation such as the film formation does not finally occur after the battery fabrication, allowing to maintain pores in the adhesive layer. For example, the fluorine-based binder may provide the adhesive layer with pores, and because the fluorine-based binder is rigid and does not substantially absorb the electrolyte, the fluorine-based binder may preserve the structure of the adhesive layer such that, for example, the pores are maintained in the adhesive layer even after battery formation.

The fluorine-based binder may include a vinylidene fluoride homopolymer, a vinylidene fluoride unit-included copolymer, a copolymer thereof, a mixture thereof, or a combination thereof. The fluorine-based binder may include polyvinylidene fluoride, polyvinylidene fluoride-co-hexafluoropropylene, polyvinylidene fluoride-co-trichloroethylene, polyvinylidene fluoride-co-tetrafluoroethylene, polyvinylidene fluoride-co-trifluoroethylene, polyvinylidene fluoride-co-trifluorochloroethylene, polyvinylidene fluoride-co-ethylene, or a combination thereof.

In the adhesive layer, a mixing ratio of the acryl-based binder and the fluorine-based binder may be about 75:25 by weight ratio to about 50:50 by weight ratio or about 75:25 by weight ratio to about 65:35 by weight ratio. When the mixing ratio of the acryl-based binder and the fluorine-based binder is within the foregoing range, excellent battery performance and suitable or desired strength of the negative electrode may be exhibited, and suitable or desired adhesion between the active material layer and the adhesive layer and suitable or desired mobility of lithium ions may be obtained.

An additive may be further included to improve the adhesion between the active material layer and the adhesive layer. The additive may be polyacrylic acid, polyvinyl alcohol, or a combination thereof. If the adhesive layer further includes the additive, an amount of the additive may be about 5 parts by weight to about 10 parts by weight based on a total, 100 parts by weight, of the adhesive layer. The amount of the additive satisfied in the range may increase the effects for improving the adhesion between the active material layer and the adhesive layer, and thus the adhesive layer may be firmly positioned on the active material layer.

The silicon-based negative active material may be Si, SiOₓ (0<x<2), an Si-Q alloy (wherein the Q is an element selected from an alkali metal, an alkaline-earth metal, a Group 13 element, a Group 14 element, a Group 15 element, a Group 16 element, a transition metal, a rare earth element, or a combination thereof, but not Si), a Si-carbon composite, or a combination thereof.

The silicon-based negative active material may include a Si-carbon composite including silicon and a crystalline carbon and/or an amorphous carbon. In one embodiment, the Si-carbon composite, for example, may be a core including a crystalline carbon and silicon particles and an amorphous carbon coating layer positioned on the surface of the core.

The crystalline carbon may be artificial graphite, natural graphite, or a combination thereof, and the amorphous carbon may be soft carbon, hard carbon, or a combination thereof.

Herein, the silicon particles may have an average particle diameter D50 of about 10 nm to about 200 nm. The Si-C composite may further include an amorphous carbon layer partially formed on at least a portion thereof, and according to one embodiment, may be a silicon-carbon composite including a core including crystalline carbon and silicon particles, and an amorphous carbon coating layer positioned on the surface of the core. Herein an amount of silicon may be about 10 wt % to about 50 wt % based on the total, 100 wt %, of the silicon-carbon composite. An amount of the crystalline carbon may be about 10 wt % to about 70 wt % based on the total weight of the silicon-carbon composite, and an amount of the amorphous carbon may be about 20 wt % to about 40 wt % based on the total weight of the silicon-carbon composite. Furthermore, the amorphous carbon coating layer may have a thickness of about 5 nm to about 100 nm.

The silicon particles may be present in an oxidized form and herein, an atomic amount ratio of Si:O in the silicon particles indicating the degree of oxidation may be about 99:1 to 33:66 by atomic ratio (or by weight ratio). The silicon particles may be SiOₓ particles, and herein, in SiOₓ, a range of x may be more than 0 and less than 2.

Unless otherwise defined in the specification, average particle diameter D50 means the diameter of particles having a cumulative volume of 50 volume % in the particle size distribution.

The average particle size (D50) may be measured by any suitable method that is generally used in the art, for example, by a particle size analyzer, and/or by a transmission electron microscopic image, and/or a scanning electron microscopic image. In some embodiments, a dynamic light-scattering measurement device is used to perform an analysis for data which is obtained using the measurement device, and the number of particles is counted for each particle size range. From this, the average particle diameter (D50) value may be obtained through a calculation.

In one embodiment, the negative active material may further include a carbon-based negative active material, together with the silicon-based negative active material. In case of further including the carbon-based negative active material, a mixing ratio of the silicon-based negative active material and the carbon-based negative active material may be about 1:99 by weight ratio to about 50:50 by weight ratio. In some embodiments, a mixing ratio of the silicon-based negative active material and the carbon-based negative active material may be about 5:95 by weight ratio to about 20:80 by weight ratio.

The carbon-based negative active material may be crystalline carbon, and the crystalline carbon may be artificial graphite, natural graphite, or a combination thereof.

In the negative active material layer, an amount of the negative active material may be about 90 wt % to about 98 wt % based on the total, 100 wt %, of the negative active material layer, or about 92 wt % to about 97 wt % (e.g., based on a total amount (100 wt %) of the negative active material layer).

The negative active material layer may include a binder, and may further include a binder and a conductive material (e.g., an electrically conductive material). When the negative active material layer further includes the binder, as a reference of the total, 100 wt % of the negative active material layer, the negative active material may be included in an amount of about 95 wt % to about 99 wt %, and the binder may be included in an amount of about 1 wt % to about 5 wt %. When the negative active material layer further includes the binder and the conductive material, as a reference of the total, 100 wt % of the negative active material layer, the negative active material may be included in an amount of about 90 wt % to about 98 wt %, the binder may be included in an amount of about 1 wt % to about 5 wt %, and the conductive material may be included in an amount of about 1 wt % to about 5 wt %.

The binder improves binding properties of negative active material particles with one another and with a current collector. The binder may be a non-aqueous binder, an aqueous binder, or a combination thereof.

The non-aqueous binder may be an ethylene propylene copolymer, polyacrylonitrile, polystyrene, polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The aqueous binder may be styrene-butadiene rubber (SBR), an acrylated styrene-butadiene rubber (ABR), acrylonitrile-butadiene rubber, an acryl rubber, a butyl rubber, a fluorine rubber, an ethylene oxide-containing polymer, polyvinylpyrrolidone, polypropylene, polyepichlorohydrin, polyphosphazene, an ethylene propylene diene copolymer, polyvinylpyridine, chlorosulfonated polyethylene, latex, a polyester resin, an acryl resin, a phenol resin, an epoxy resin, polyvinyl alcohol, or a combination thereof.

When the aqueous binder is used as a negative electrode binder, a cellulose-based compound may be further used to provide (e.g., increase) viscosity as a thickener. The cellulose-based compound includes one or more of carboxymethyl cellulose, hydroxypropyl methylcellulose, methyl cellulose, and/or alkali metal salts thereof. The alkali metal may be Na, K, and/or Li. The thickener may be included in an amount of about 0.1 parts by weight to about 3 parts by weight based on 100 parts by weight of the negative active material.

The conductive material is included to provide electrode conductivity (e.g., electrical conductivity), and any suitable electrically conductive material may be used as a conductive material unless it causes a chemical change (e.g., an undesirable change in the rechargeable lithium battery). Examples of the conductive material include: a carbon-based material such as natural graphite, artificial graphite, carbon black, acetylene black, ketjen black, a carbon fiber, and the like; a metal-based material of a metal powder and/or a metal fiber including copper, nickel, aluminum, silver, and the like; a conductive polymer such as a polyphenylene derivative; or a mixture thereof.

The current collector may include one selected from a copper foil, a nickel foil, a stainless steel foil, a titanium foil, a nickel foam, a copper foam, a polymer substrate coated with a conductive metal (e.g., an electrically conductive metal), and a combination thereof, but is not limited thereto.

According to embodiments, the negative electrode may have a bending strength of about 0.5 N or less, or about 0.3 N to about 0.4 N. When the bending strength of the negative electrode is about 0.5 N or less, suitable or desired rigidity to suitably or sufficiently inhibit or reduce the shrinkage and expansion of volume of the silicon-based negative active material may be exhibited, and no (or substantially no) breakage may occur during battery fabrication. If the bending strength of the negative electrode is more than about 0.5 N, breakage during battery fabrication may occur. Additionally, when the bending strength of the negative electrode is more than about 0.5 N, the amount of the binder included in the negative electrode is larger, which limits or reduces the movement of lithium ions during cycles, and thus, the cycle-life characteristics may be deteriorated or reduced.

In one embodiment, the bending strength may be measured by a three-point bending strength test.

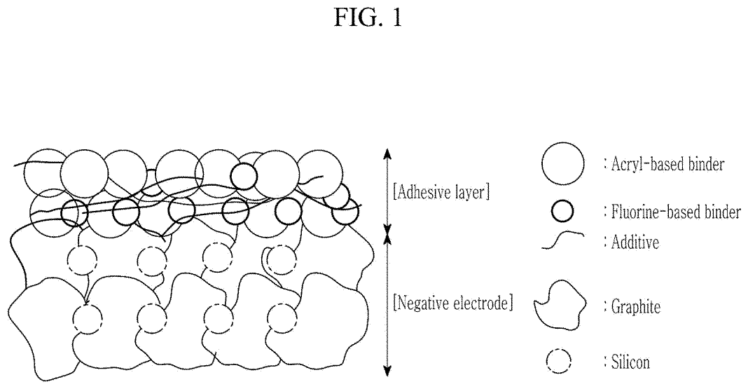

FIG. 1 shows a configuration of the negative active material layer and the adhesive layer in the negative electrode according to one embodiment. FIG. 1 shows that the negative active material of the negative active material layer is graphite and silicon, but as described above, the negative active material is not limited to the negative active material being a mixture of graphite and silicon. FIG. 1 shows that the adhesive layer includes the additive, but, as described above, the additive may not be included. For example, the additive may be omitted. As shown in FIG. 1, the adhesive layer may be formed on the surface of the active material layer in a dot pattern.

The adhesive layer may be prepared by an electrospinning process. According to one embodiment, a composition for the adhesive layer including the acryl-based binder, the fluorine-based binder, and a solvent may be electrospun to the negative active material layer to form an adhesive layer.

As such, when the adhesive layer is formed by electrospinning, the adhesive layer may be formed in a dot pattern. If the preparation of the adhesive layer is prepared by impregnation and/or other spinning such as spraying and/or blade coating, an adhesive layer in a dot pattern is not prepared. This may be due to a balance mechanism because the applied electrical force and the surface tension of a material at a tip generated during the electrospinning.

The electrospinning may be performed under a condition of about 20 kV to about 40 kV for 1 second or more and less than 20 seconds. The electrospinning under the condition may well form the adhesive layer in the dot pattern. In addition, the electrospinning for the time within the above range may prepare the adhesive layer to be about 50 area % or less based on the total area of the negative active material layer.

The solvent may be water.

Another embodiment provides a rechargeable lithium battery including the negative electrode, a positive electrode, and an electrolyte.

The positive electrode may include a current collector and a positive active material layer formed on the current collector.

The positive electrode active material may include lithiated intercalation compounds that reversibly intercalate and deintercalate lithium ions. In some embodiments, one or more composite oxides of a metal selected from cobalt, manganese, nickel, and a combination thereof, and lithium may be used. For example, the compounds represented by one of the following chemical formulae may be used. LiₐA_{1-b}X_{b}D₂(0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0 ≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}Dₐ (0.90≤a≤1.8, 0≤b≤0.5, 0≤c≤0.5, 0≤a≤2); LiₐNi_{1-b-c}Co_{b}X_{c}O₂₋ₐTₐ (0.90≤a≤1.8, 0≤b≤0.5, 0≤c≤0.5, 0<a<2); LiₐNi_{1-b-c}Co_{b}X_{c}O₂₋ₐT₂(0.90≤a≤1.8, 0≤b≤0.5, 0≤c≤0.5, 0<a<2); LiₐNi_{1-b-c}Mn_{b}X_{c}Dₐ (0.90≤a≤1.8, 0≤b≤0.5, 0≤c≤0.5, 0<a≤2); LiₐNi_{1-b-c}Mn_{b}X_{c}O₂₋ₐTₐ (0.90≤a≤1.8, 0≤b≤0.5, 0≤c≤0.05, 0<a<2); LiₐNi_{1-b-c}Mn_{b}X_{c}O₂₋ₐT₂(0.90≤a≤1.8, 0≤b≤0.5, 0≤c≤0.5, 0<a<2); LiₐNi_{b}E_{c}G_{d}O₂(0.90≤a≤1.8, 0≤b≤0.9, 0=c≤0.5, 0.001≤d≤0.1); LiₐNi_{b}Co_{c}Mn_{d}GₑO₂(0.90≤a≤1.8, 0≤b≤0.9, 0≤c≤0.5, 0≤d≤0.5, 0≤e≤0.1); LiₐNi_{b}Co_{c}Al_{d}GₑO₂(0.90≤a≤1.8, 0≤b≤0.9, 0≤c≤0.5, 0≤d≤0.5, 0≤e≤0.1); LiₐNi_{b}Co_{c}Mn_{d}GₑO₂(0.90≤a≤1.8, 0≤b≤0.9, 0≤c≤0.5, 0≤d≤0.5, 0.001≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤0.001≤b≤0.1); LiₐMn_{1-g}G_{g}PO₄(0.90≤a≤1.8, 0≤g≤0.5); QO₂; QS₂; LiQS₂; V₂O₅; LiV₂O₅; LiZO₂ LiNiVO₄ Li_{(3-f)}J₂(PO₄)₃(0≤f ≤2); Li_{(3-f)}Fe₂(PO₄)₃ (0≤f≤2); and LiₐFePO₄ (0.90≤a≤1.8).

In the above chemical formulae, A is selected from Ni, Co, Mn, and a combination thereof; X is selected from Al, Ni, Co, Mn, Cr, Fe, Mg, Sr, V, a rare earth element, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

Also, the compounds may have a coating layer on the surface, or may be mixed together with another compound having a coating layer. The coating layer may include at least one coating element compound selected from the group consisting of an oxide of the coating element, a hydroxide of the coating element, an oxyhydroxide of the coating element, an oxycarbonate of the coating element, and a hydroxyl carbonate of the coating element. The compound for the coating layer may be amorphous and/or crystalline. The coating element included in the coating layer may include Mg, Al, Co, K, Na, Ca, Si, Ti, V, Sn, Ge, Ga, B, As, Zr, or a mixture thereof. The coating layer may be formed utilizing a method having no (or substantially no) adverse influence on properties of a positive electrode active material by using these elements in the compound, and for example, the method may include any suitable coating method such as spray coating, dipping, and/or the like, but is not illustrated in more detail because it should be readily apparent to those of ordinary skill in the art upon reviewing this disclosure.

In the positive electrode, an amount of the positive active material may be about 90 wt % to about 98 wt % based on the total weight of the positive active material layer.

In an embodiment of the present disclosure, the positive active material layer may further include a binder and a conductive material (e.g., an electrically conductive material). Herein, the binder and the conductive material may be included in an amount of about 1 wt % to about 5 wt %, respectively based on the total amount of the positive active material layer.

The binder improves binding properties of positive electrode active material particles with one another and with a current collector. Examples of the binder may be polyvinyl alcohol, carboxymethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, styrene butadiene rubber, acrylated styrene butadiene rubber, an epoxy resin, nylon, and the like, but are not limited thereto.

The conductive material is included to provide electrode conductivity (e.g., electrical conductivity), and any suitable electrically conductive material may be used as a conductive material unless it causes a chemical change (e.g., an undesirable change in the rechargeable lithium battery). Examples of the conductive material include: a carbon-based material such as natural graphite, artificial graphite, carbon black, acetylene black, ketjen black, a carbon fiber, and the like; a metal-based material of a metal powder and/or a metal fiber including copper, nickel, aluminum, silver, and the like; a conductive polymer such as a polyphenylene derivative; or a mixture thereof.

The current collector may use aluminum foil, nickel foil, or a combination thereof, but is not limited thereto.

The electrolyte includes a non-aqueous organic solvent and a lithium salt.

The non-aqueous organic solvent serves as a medium that transmits ions taking part in the electrochemical reaction of a battery.

The non-aqueous organic solvent may include a carbonate-based, ester-based, ether-based, ketone-based, alcohol-based, and/or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, dimethyl acetate, methyl propionate, ethyl propionate, propyl propionate decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. Furthermore, the ketone-based solvent may include cyclohexanone and/or the like. The alcohol-based solvent may include ethyl alcohol, isopropyl alcohol, and/or the like, and examples of the aprotic solvent include nitriles such as R-CN (where R is a C₂ to C₂₀ linear, branched, and/or cyclic hydrocarbon, and may include a double bond, an aromatic ring, and/or an ether bond), amides such as dimethylformamide, dioxolanes such as 1,3-dioxolane, sulfolanes, and/or the like.

The organic solvent may be used alone or in a mixture. When the organic solvent is used in a mixture, the mixture ratio may be controlled in accordance with a suitable or desirable battery performance and it may be any suitable one generally used in the art.

Furthermore, the carbonate-based solvent may suitably or desirably include a mixture with a cyclic carbonate and a linear carbonate. The cyclic carbonate and linear carbonate are mixed together in a volume ratio of about 1:1 to about 1:9, and when the mixture is used as an electrolyte, it may have enhanced performance.

The organic solvent may further include an aromatic hydrocarbon-based solvent as well as the carbonate-based solvent. The carbonate-based solvent and the aromatic hydrocarbon-based solvent may be mixed together in a volume ratio of about 1:1 to about 30:1.

The aromatic hydrocarbon-based organic solvent may be an aromatic hydrocarbon-based compound represented by Chemical Formula 1.

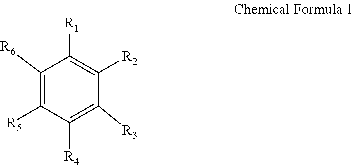

In Chemical Formula 1, R₁ to R₆ are the same or different and are selected from hydrogen, a halogen, a C₁ to C₁₀ alkyl group, a haloalkyl group, and a combination thereof.

Examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The electrolyte may further include vinylene carbonate, and/or an ethylene carbonate-based compound represented by Chemical Formula 2, as an additive for improving cycle life.

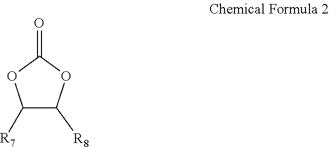

In Chemical Formula 2, R₇ and R₈ are the same or different and may each independently be hydrogen, a halogen, a cyano group (CN), a nitro group (NO₂), or a C1to C5 fluoroalkyl group, provided that at least one of R₇ and R₈ is a halogen, a cyano group (CN), a nitro group (NO₂), or a C1 to C5 fluoroalkyl group, and R₇ and R₈ are not simultaneously hydrogen.

Examples of the ethylene carbonate-based compound may be difluoro ethylene carbonate, chloroethylene carbonate, dichloroethylene carbonate, bromoethylene carbonate, dibromoethylene carbonate, nitroethylene carbonate, cyanoethylene carbonate or fluoroethylene carbonate, and the like. An amount of the additive for improving the cycle-life characteristics may be used within a suitable or appropriate range.

The lithium salt dissolved in an organic solvent supplies a battery with lithium ions, basically operates the rechargeable lithium battery, and improves transportation of the lithium ions between a positive electrode and a negative electrode. Examples of the lithium salt include at least one or two supporting salts selected from LiPF₆, LiBF₄, LiSbF₆, LiAsF₆, LiN(SO₂C₂F₅)₂, Li(CF₃SO₂)₂N, LiN(SO₃C₂F₅)₂, Li(FSO₂)₂N(lithium bis(fluorosulfonyl)imide: LiC₄F₉SO₃, LiCIO₄, LiAlO₂, LiAlCl₄, LiPO₂F₂, LiN(CₓF₂ₓ₊₁SO₂)(C_{y}F_{2y+1}SO₂), wherein, x and y are natural numbers, for example, an integer of 1 to 20, lithium difluoro(bisoxolato) phosphate), LiCl, Lil, LiB(C₂O₄)₂ (lithium bis(oxalato) borate: LiBOB), and lithium difluoro(oxalato)borate (LiDFOB). A concentration of the lithium salt may be in a range from about 0.1 M to about 2.0 M. When the lithium salt is included at the above concentration range, an electrolyte may have excellent performance and lithium ion mobility due to suitable or optimal electrolyte conductivity and viscosity.

A separator may be between the positive electrode and the negative electrode depending on a type (or kind) of a rechargeable lithium battery. The separator may use polyethylene, polypropylene, polyvinylidene fluoride, or multi-layers thereof having two or more layers, and may be a mixed multilayer such as a polyethylene/polypropylene double-layered separator, a polyethylene/polypropylene/polyethylene triple-layered separator, a polypropylene/polyethylene/polypropylene triple-layered separator, and/or the like.

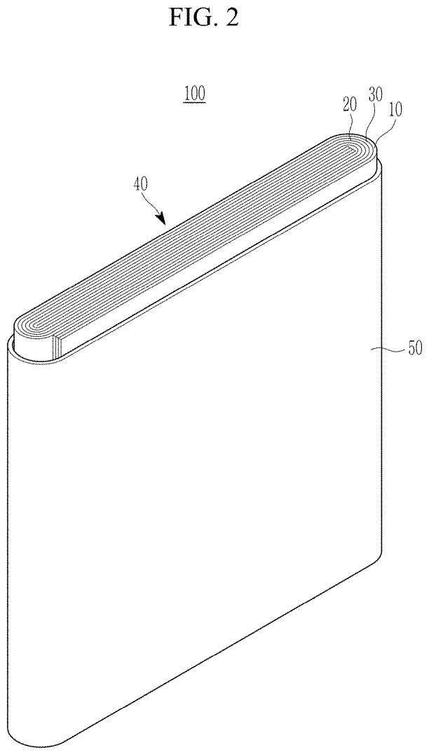

FIG. 2 is an exploded perspective view of a rechargeable lithium battery according to an embodiment. The rechargeable lithium battery according to an embodiment is illustrated as a prismatic battery but is not limited thereto, and may include variously-shaped batteries such as a cylindrical battery, a pouch battery, and/or the like.

Referring to FIG. 2, a rechargeable lithium battery 100 according to an embodiment may include an electrode assembly 40 manufactured by winding a separator 30 between a positive electrode 10 and a negative electrode 20, and a case 50 housing the electrode assembly 40. An electrolyte may be impregnated in the positive electrode 10, the negative electrode 20, and the separator 30.

Hereinafter, examples of the present disclosure and comparative examples are described. These examples, however, are not in any sense to be interpreted as limiting the scope of the present disclosure.

### EXAMPLE 1

96 wt % of a mixture of graphite and a Si-carbon composite negative active material (86 wt % of graphite and 14 wt % of the Si-carbon composite), 2 wt % of ketjen black, 1 wt % of carboxymethyl cellulose, and 1 wt % of styrene-butadiene rubber were mixed together in a water solvent to prepare a negative active material layer slurry. Herein, the Si-carbon composite including a core having artificial graphite and silicon particles, and a soft carbon coating layer formed on the core, was used. The soft carbon coating layer had a thickness of 20 nm and the silicon particles had an average a particle diameter D50 of 100 nm.

70 wt % of an acryl-based binder, 25 wt % of a fluorine-based binder, and 6 wt % of a polyacrylic acid additive were mixed together in a water solvent to prepare an adhesive layer slurry.

The negative active material layer slurry was coated on a copper foil current collector, dried, and pressed by a general technique to prepare a negative active material layer.

The adhesive layer slurry was electrospun to the negative active material layer under a condition of 30 kV for 2.5 seconds to prepare an adhesive layer, thereby obtaining a negative electrode. Herein, the resulting adhesive layer had a thickness of 1 μm to 2 μm, had an area of 5 area %, and the adhesive layer was prepared to have a dot pattern.

Using the negative electrode, a polyethylene/polypropylene separator, a lithium metal counter electrode, and an electrolyte, a half-cell was fabricated by a general procedure utilized in the art. As the electrolyte, 1.0 M LiPF₆ dissolved in a mixed solvent of ethylene carbonate and diethyl carbonate (50:50 volume ratio) was used.

### EXAMPLE 2

A negative electrode was prepared by substantially the same procedure as in Example 1, except that the electrospinning was performed for 5 seconds to prepare an adhesive layer to be an area of 25% based on the total, 100% of the negative active material layer. A half-cell was prepared by substantially the same procedure as in Example 1 using the negative electrode.

### EXAMPLE 3

A negative electrode was prepared by substantially the same procedure as in Example 1, except that the electrospinning was performed for 10 seconds to prepare an adhesive layer to be an area of 50% based on the total, 100% of the negative active material layer. A half-cell was prepared by substantially the same procedure as in Example 1 using the negative electrode.

### COMPARATIVE EXAMPLE 1

96 wt % of a mixture of graphite and a Si-carbon composite negative active material (86 wt % of graphite and 14 wt % of the Si-carbon composite), 2 wt % of ketjen black, 1 wt % of carboxymethyl cellulose, and 1 wt % of styrene-butadiene rubber were mixed together in a water solvent to prepare a negative active material layer slurry. Herein, the Si-carbon composite including a core having artificial graphite and silicon particles, and a soft carbon coating layer formed on the core, was used. The soft carbon coating layer had a thickness of 20 nm and the silicon particles had an average particle diameter D50 of 100 nm.

The negative active material layer slurry was coated on a copper foil current collector, dried, and pressed by a general technique utilized in the art to prepare a negative electrode.

A half-cell was prepared by substantially the same procedure as in Example 1 using the negative electrode.

### COMPARATIVE EXAMPLE 2

A negative electrode was prepared by substantially the same procedure as in Example 1, except that the electrospinning was performed for 20 seconds to prepare an adhesive layer to be area of 100% based on the total, 100% of the negative active material layer. A half-cell was prepared by substantially the same procedure as in Example 1 using the negative electrode.

### EXPERIMENTAL EXAMPLE 1

### Measurement by SEM

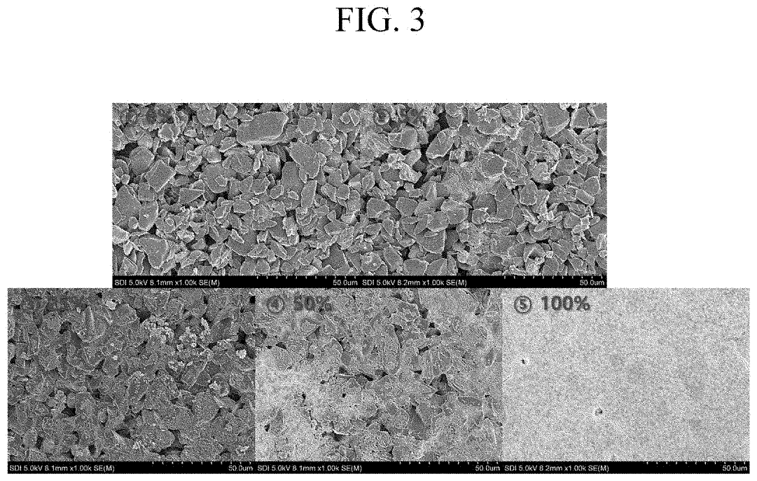

The surface SEM photographs for the negative active material layers in the negative electrodes according to Examples 1 to 3 and Comparative Examples 1 and 2 were measured. Among results, the 1000×-magnification photograph results are shown in FIG. 3. In FIG. 3, \hat{1} indicates the SEM photograph of Comparative Example 1, \hat{2} indicates the SEM photograph of Example 1, \hat{3} indicates the SEM photograph of Example 2, \hat{4} indicates the SEM photograph of Example 3, and \hat{5} indicates the SEM photograph of Comparative Example 2.

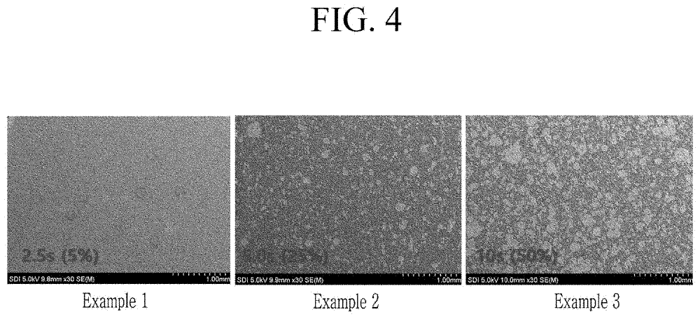

In addition, the surface SEM photograph (30× magnification) for the negative active material layer in the negative electrode according to Examples 1 to 3 are shown in FIG. 4.

As shown in FIG. 3, electrospinning for 5 seconds or less forms an adhesive layer to have 25 area % or less based on the total area of the negative active material layer and electrospinning for 10 seconds forms an adhesive layer to have 50 area % based on the total area of the negative active material layer. Whereas, it can be seen that when the electrospinning is performed for 20 seconds, the adhesive having 100 area % is formed.

Furthermore, as shown in FIG. 4, the adhesive layer is formed in a dot pattern.

### EXPERIMENTAL EXAMPLE 2

### Evaluation of Bending Strength

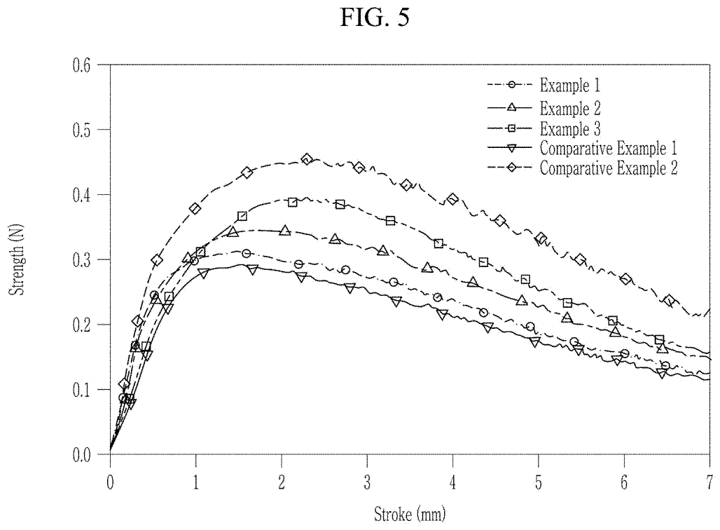

The bending strength of the negative electrode according to Examples 1 to 3 and Comparative Examples 1 and 2 were measured by a three-point bending strength test. The results are shown in FIG. 5. In addition, from the results shown in FIG. 5, the maximum values of the bending strength are shown in Table 1 as a maximum load.

TABLE 1

| | Area ratio (%) | Maximum load (N) |
|---|---|---|
| Comparative | 0 | 0.29 |
| Example 1 | | |
| Example 1 | 5 | 0.31 |
| Example 2 | 25 | 0.35 |
| Example 3 | 50 | 0.40 |
| Comparative | 100 | 0.45 |
| Example 2 | | |

As shown in Table 1, as the area ratio of the adhesive layer increases, the maximum load increases. From these results, it can be seen the increase in the area ratio results in an increase in the rigidity of the negative electrode.

### EXPERIMENTAL EXAMPLE 3

### Evaluation of Cycle-Life Characteristic

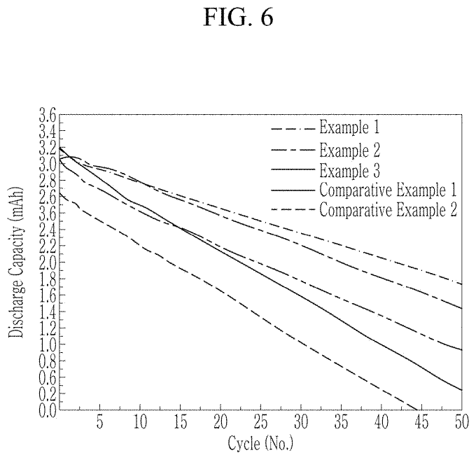

The half-cells according to Examples 1 to 3 and Comparative Examples 1 and 2 were charged and discharged at 0.33 C for 50 cycles. The discharge capacity at each cycle was measured. The results are shown in FIG. 6.

As shown in FIG. 6, the half-cell in which the adhesive layers were formed in 5 area %, 25 area %, and 50 area % according to Example 1 to 3 exhibited a small amount of capacity fading as cycles were repeated, and thus, the cycle-life characteristics were excellent. Whereas, Comparative Example 2 in which the adhesive layer was formed in an area of 100% based on the total area of the active material layer, even though the adhesive layer was formed, it exhibited very low initial discharge capacity and abrupt fading of capacity, so that substantially reduced capacity was exhibited. Further, Comparative Example 1 with no adhesive layer exhibited adequate initial capacity, but exhibited significant reductions to capacity during the 50 cycles.

While the subject matter of this disclosure has been described in connection with what is presently considered to be practical example embodiments, it is to be understood that the present disclosure is not limited to the disclosed embodiments, but, on the contrary, is intended to cover various modifications and equivalent arrangements included within the scope of the appended claims and attached drawings.

What is claimed is:

1. A negative electrode for a rechargeable lithium battery, comprising:
a current collector;
a negative active material layer on the current collector and comprising a silicon-based negative active material; and
an adhesive layer on the negative active material layer,
wherein the adhesive layer has a thickness of about 5 μm or less,
the adhesive layer has an area of about 50 area % or less based on the total area of the negative active material layer, and
the adhesive layer is positioned in a dot pattern.

2. The negative electrode for a rechargeable lithium battery of claim 1, wherein the adhesive layer has a thickness of about 1 μm to about 5 μm.

3. The negative electrode for a rechargeable lithium battery of claim 1, wherein the adhesive layer has an area of about 5 area % to about 50 area % based on the total area of the negative active material layer.

4. The negative electrode for a rechargeable lithium battery of claim 1, wherein the adhesive layer comprises an acryl-based binder and a fluorine-based binder.

5. The negative electrode for a rechargeable lithium battery of claim 4, wherein a mixing ratio of the acryl-based binder and the fluorine-based binder is about 75:25 by weight ratio to about 50:50 by weight ratio.

6. The negative electrode for a rechargeable lithium battery of claim 4, wherein the acryl-based binder comprises poly(meth)acrylic acid, poly(meth)acrylate, polymethyl(meth)acrylate, polyacrylonitrile, an acrylonitrile-styrene-butadiene copolymer, a copolymer thereof, a mixture thereof, or a combination thereof.

7. The negative electrode for a rechargeable lithium battery of claim 4, wherein the fluorine-based binder comprises polyvinylidene fluoride, polyvinylidene fluoride-co-hexafluoropropylene, polyvinylidene fluoride-co-trichloroethylene, polyvinylidene fluoride-co-tetrafluoroethylene, polyvinylidene fluoride-co-trifluoro ethylene, polyvinylidene fluoride-co-trifluoro chloroethylene and polyvinylidene fluoride-co-ethylene, or a combination thereof.

8. The negative electrode for a rechargeable lithium battery of claim 1, wherein the negative electrode has bending strength of about 0.5 N or less.

9. The negative electrode for a rechargeable lithium battery of claim 1, wherein the negative electrode further comprises a carbon-based negative active material.

10. A rechargeable lithium battery, comprising
a negative electrode of claim 1;
a positive electrode; and
an electrolyte.
